(19) United States
(12) Patent Application Publication
(10) Pub. No.: US 2003/0106387 A1
(43) Pub. Date: Jun. 12, 2003

(54) Engaging-by-gear-positions type shift lever lock

(76) Inventor: Chun-Chang Lee, Thaishan Village (TW)

Correspondence Address: BACON & THOMAS, PLLC, 625 SLATERS LANE, FOURTH FLOOR, ALEXANDRIA, VA, 22314

(21) Appl. No.: 10/006,219

(22) Filed: Dec. 10, 2001

(51) Int. Cl. G05G 5/00; B60K 20/00

(52) U.S. Cl. 74/473.21; 74/473.3

(57) ABSTRACT

An engaging-by-gear-positions shift lever lock, the lock is provided on the top thereof with a shift lever head attached with an insertion portion, and is provided with a cylinder to cooperatively make locking between the shift lever head and the shank of the shift lever. Thereby, when the shift lever is moved to a transition position of a channel having a plurality of gear positions, the head of the shift lever can be pulled down to render the insertion portion on the lower end thereof to insert in the shank of the shift lever and in a space at the transition position, so that the shank of the shift lever and the channel for the gear positions can engage with each other. Thereby, and an effect of locking of the shift lever is attained.

### BACKGROUND OF THE INVENTION

1. Field of the Invention

The present invention is related to an engaging-by-gear-positions type shift lever lock, and especially to a manual/automatic shift lever locking structure which can lock effectively a manual/automatic shift lever, the head of the shift lever is provided on the bottom thereof with an insertion portion capable of inserting in a space at a transition position on a channel having a plurality of gear positions, so that the shank of the shift lever is limited to being in the shift lever seat and can not get into any gear position or to make gear shifting, and a locking effect for theft proofing is attained.

2. Description of the Prior Art

Conventional manual/automatic shift lever seat structures for cars each is extended into a channel having a plurality of gear positions in the shift lever seat, while the channel for the gear positions of the shift lever seat is designed to have longitudinal and transverse transition positions in order that a guiding function can be formed to remind an operator to change acting direction when the operator is to push the shank of the shift lever into a gear position or to make gear shifting. This can clearly let the operator be aware of changing of gear position, and is helpful to reaction capability in changing car speed and can increase pleasant sensation of driving.

However, in such a design for transition within the channel for the gear positions on a manual/automatic shift lever seat for cars, although an operator can quickly complete a gear shifting action during the transient moment of loosening the accelerator, by the fact that the structure between the shank of the shift lever and the shift lever seat is not the same structure as a normal structure for a manual or an automatic gear shifting car; the lock used therein for locking the shift lever can not be used straightly here, or it can not really meet the shift lever locking mode of the manual/automatic shifting car functionally.

### SUMMARY OF THE INVENTION

Therefore, the primary object of the present invention is to provide an engaging-by-gear-positions type shift lever lock, wherein, a movable sleeve is provided in a shift lever head, and a fixed sleeve able to insert in the movable sleeve is provided on the shank of the shift lever. A rotatable block of which rotation is limited by a cylinder of the lock is provided at a location where a positioning pin for the fixed and the movable sleeves is, so that the rotatable block has a function to limit the fixed and the movable sleeves to not mutual sliding rotationally. Thereby, when the cylinder is rotated to make rotating of the rotatable block to relieve engagement between the fixed and the movable sleeves, the shift lever head can be pressed down to make sure insertion of an insertion portion on the bottom of the shift lever head in a transition position on the channel having the gear positions. Then the rotatable block is reversely rotated to again limit the fixed and the movable sleeves to not sliding rotationally, thereby, engagement at the transition position between the insertion portion and the channel for the gear positions is fixedly locked, and an effect of locking the shift lever can be achieved.

The present invention will be apparent after reading the detailed description of the preferred embodiment thereof in reference to the accompanying drawings.

### BRIEF DESCRIPTION OF THE DRAWINGS

FIG. 1 is a schematic perspective view showing the appearance of the present invention wherein the whole shift lever is in an unlocking state;

FIG. 2 is an analytic perspective view of the lock structure of the present invention;

FIG. 3 is sectional view showing the lock structure of the present invention;

FIG. 4 is a schematic view showing a rotating state of a rotatable block of the present invention;

FIG. 5 is a schematic view showing a shift lever head of the present invention is pressed down;

FIG. 6 is a schematic view showing the reverse rotating state of the rotatable block of the present invention;

FIG. 7 is a schematic perspective view showing the appearance of the present invention wherein the whole shift lever is in a locking state;

FIG. 8 is a schematic sectional view showing a locking screw of the present invention obscured by a movable sleeve;

FIG. 9 is a sectional view showing another embodiment of lock structure of the present invention.

### DETAILED DESCRIPTION OF THE PREFERRED EMBODIMENT

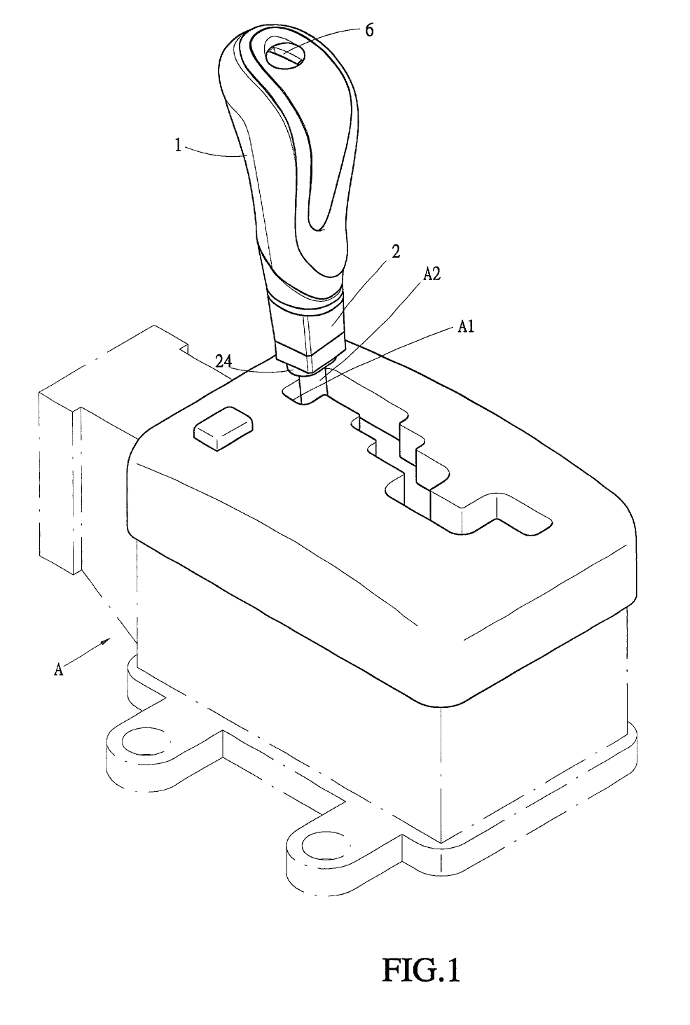

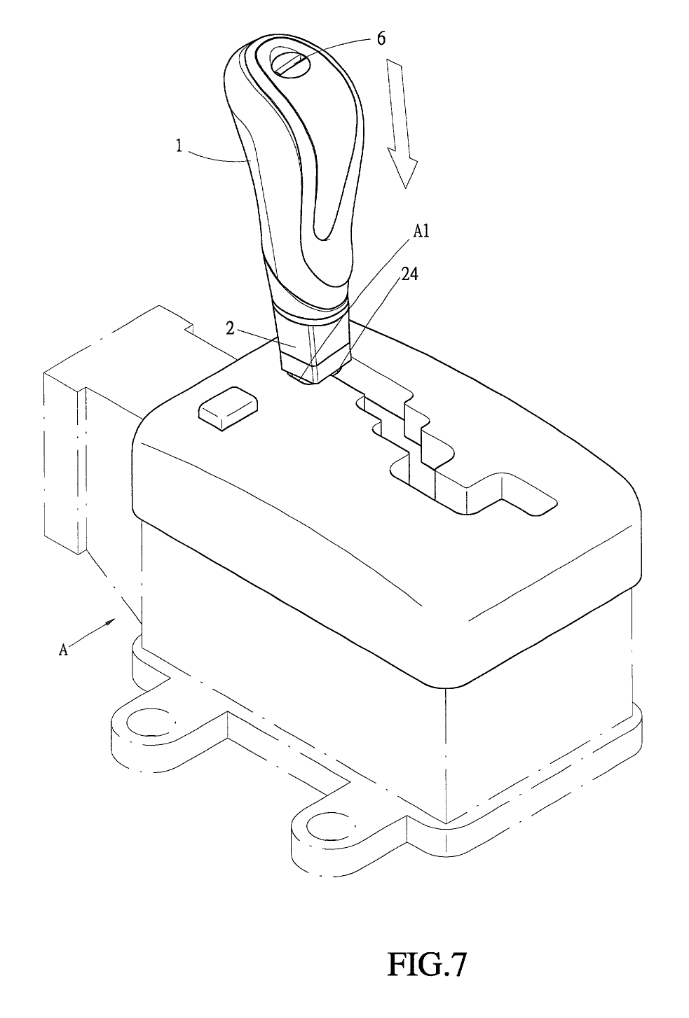

Referring to FIG. 1, the engaging-by-gear-positions type shift lever lock of the present invention is comprised of a shift lever seat “A”, the shank A2 of the shift lever is extended into a channel A1 having a plurality of gear positions in the shift lever seat “A”, so that transition of the positions on the channel A1 can make gear shifting of the shank A2 of the shift lever. And application and arrangement of the lock structure to form a locking function on the shift lever mainly include providing a shift lever head 1 on the shank A2 of the shift lever. The shift lever head 1 can slide up and down along the shank A2 of the shift lever, and is provided on the bottom thereof with an insertion portion 24 capable of inserting in a transition position on the channel A1 for the gear positions. The shift lever head 1 is also provided with a cylinder 6 for firmly locking the shift lever head 1 on the shank A2 of the shift lever. As shown in FIG. 7, when the lock as a whole is pressed down by means of the shift lever head 1 and is firmly locked, the insertion portion 24 on the bottom thereof is inserted at a transition position on the channel A1 having the gear positions to fill up the space at the transition position, thereby, the shank A2 of the shift lever can not be moved, and the effect of locking of the shift lever is achieved.

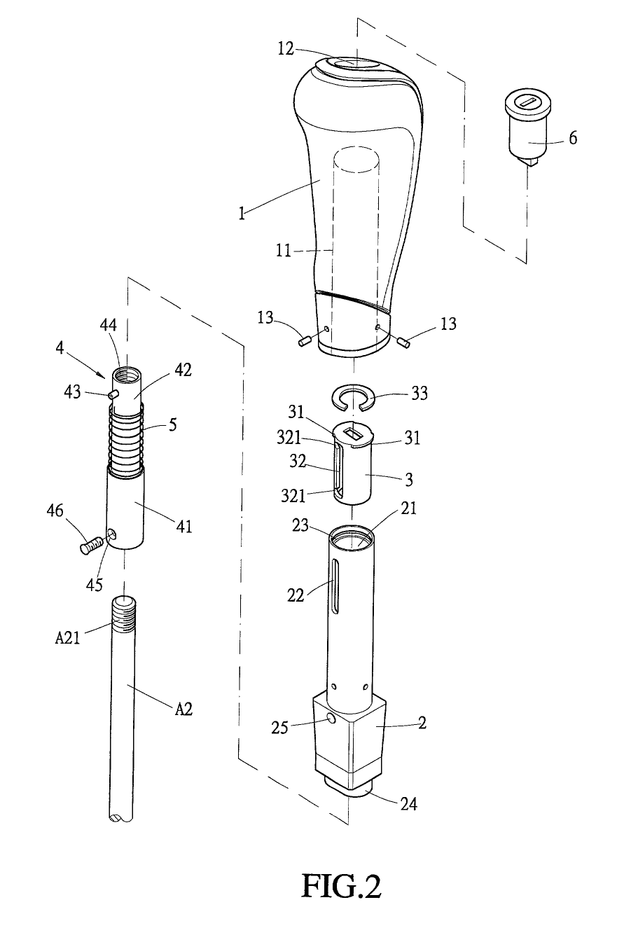

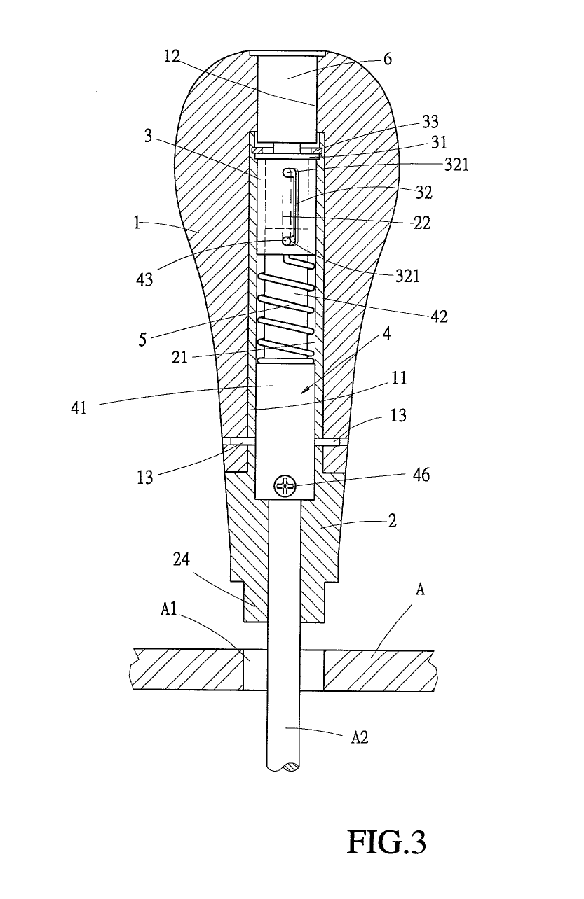

Referring simultaneously to FIGS. 2 and 3, a movable sleeve 2 is provided in the shift lever, the top of the movable sleeve 2 is directly slipped in a receiving hole 11 from the bottom of the shift lever head 1, and is fixed by inserting therein a plurality of fixing pins 13. The bottom of the movable sleeve 2 can allow inserting of the shank A2 of the shift lever therein, and is provided on the main body thereof with a receiving bore 21 to allow inserting of a fixed sleeve 4 therein. Partial section of the fixed sleeve 4 is the first slipping over portion 41 capable of inserting into the receiving bore 21 of the movable sleeve 2; the other section of the fixed sleeve 4 is the second slipping over portion 42 capable of inserting into a rotatable block 3. The fixed sleeve 4 and the movable sleeve 2 are respectively provided with a positioning pin 43 and a first slot 22 mutually cooperative; the rotatable block 3 receives the positioning pin 43 and is mounted between the fixed sleeve 4 and the movable sleeve 2. Wherein, the rotatable block 3 is provided thereon with a flange 31 which can be received in a positioning annular groove 23 in the receiving bore 21 of the movable sleeve 2 and can be positioned here by a locking ring 33. The shift lever head 1 has a cylinder receiving hole 12 located above the rotatable block 3, and the cylinder 6 is fixedly received in the cylinder receiving hole 12 to control rotation of the rotatable block 3.

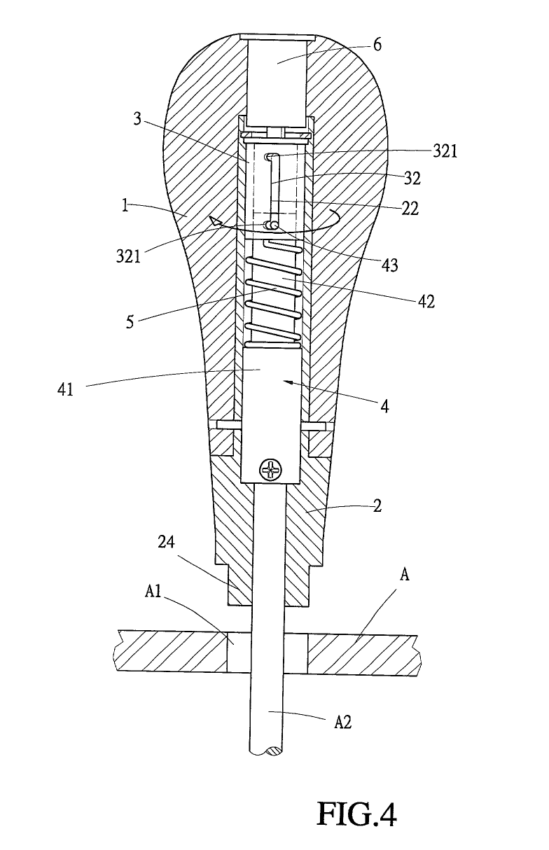

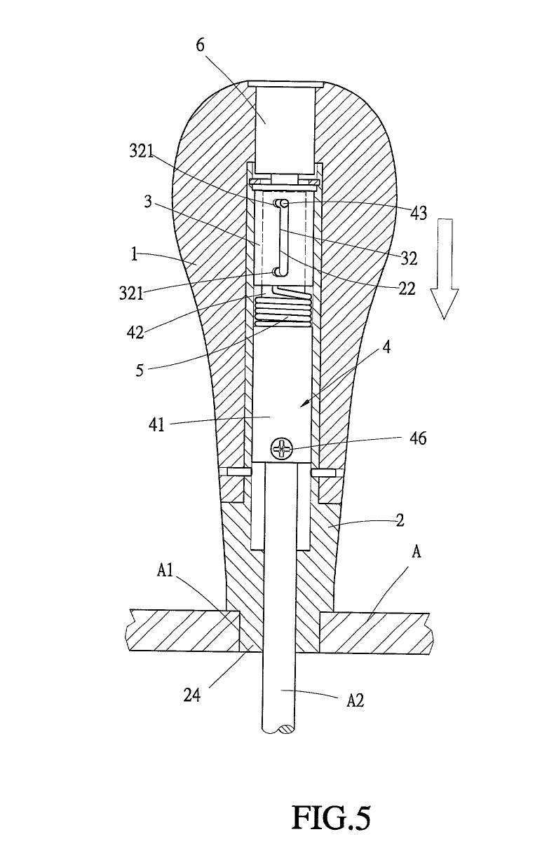

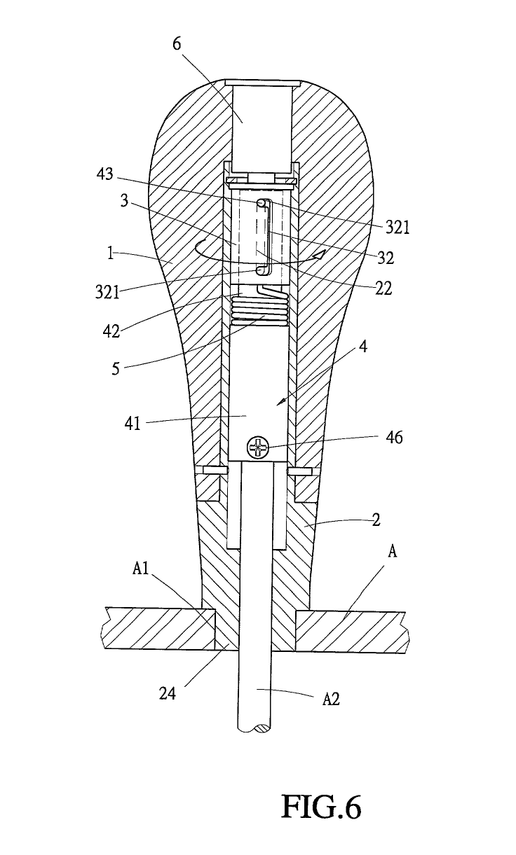

And more, the rotatable block 3 further is provided with a second slot 32 capable of aligning with the first slot 22, and the upper and the lower terminal ends of the second slot 32 forming the terminals of the stroke of the positioning pin 43 are provided with stop notches 321. The end of the rotatable block 3 contacts a spring 5 to form an elastic restoring force and a reverse rotating force for the rotatable block 3; thereby, as shown in FIG. 3, when in the unlocking state normally, the shift lever head 1 is maintained in an upper position by the action of the spring 5. The rotatable block 3 allows the positioning pin 43 to get into a stop notch 321 and to be prevented from sliding vertically in the first slot 22, thereby, the whole lock can be maintained in the unlocking state without influencing movement of the shank A2 of the shift lever. When in locking as shown in FIG. 4, a key rotates the cylinder 6 to rotate the rotatable block 3 to make the positioning pin 43 get out of the stop notch 321, and to make alignment of the second slot 32 with the first slot 22. At this time, limitation on the positioning pin 43 is released; and as shown in FIG. 5, the shift lever head 1 is pressed down to make sure insertion of the insertion portion 24 on the bottom of the shift lever head 1 in the transition position on the channel A1 for the gear positions. Now, the positioning pin 43 has been moved to the other end of its stroke in the first slot 22. And as shown in FIG. 6, the cylinder 6 is rotated to reversely rotate the rotatable block 3, so that the positioning pin 43 gets into another stop notch 321 to again form limitation to prevent mutual rotational sliding between the fixed sleeve 4 and the movable sleeve 2. In this way, the insertion portion 24 and the transition position on the channel A1 for the gear positions can be locked in their engaging state, and the whole lock is in the state as shown in FIG. 7.

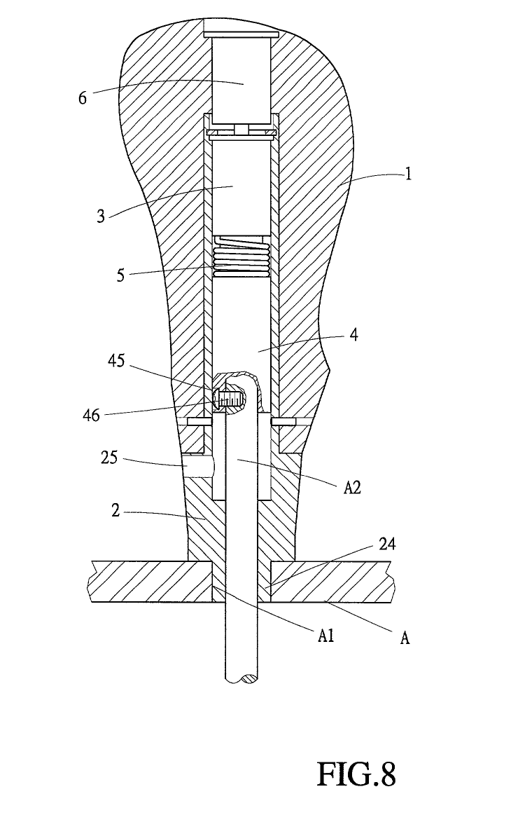

And as shown in FIGS. 2 and 8, by virtue that the fixed sleeve 4 is fixedly connected with the shank A2 of the shift lever, a screw hole 44 capable of threaded connecting with a thread section A21 on the shank A2 of the shift lever is provided on the inner circle of the fixed sleeve 4, so that the fixed sleeve 4 can be screw connected with the shank A2 of the shift lever in a locking state, and a fixing screw 46 can be transversely screwed in the fixed sleeve 4 and the shank A2 of the shift lever to connect them in the locking state. By the fact that the fixed sleeve 4 is inserted in the movable sleeve 2, a screw hole 25 can be provided on the movable sleeve 2 at a location in corresponding to a fish-eye hole 45 provided on the fixed sleeve 4 for extending therethrough the fixing screw 46; thereby, when in the unlocking state, the screw hole 25 and the fish-eye hole 45 can be aligned with each other in favor of locking connection or detachment of the fixed sleeve 4 by a user. And when the whole lock is in the locking state, the movable sleeve 2 is pulled down and is locked by the cylinder 6 at the lower position thereof; hence the screw hole 25 and the fish-eye hole 45 can not align or communicate with each other by down moving of the movable sleeve 2, and the fixing screw 46 does not expose to thereby prevent the fixed sleeve 4 from detachment, the whole lock can thus avoid being destroyed at will.

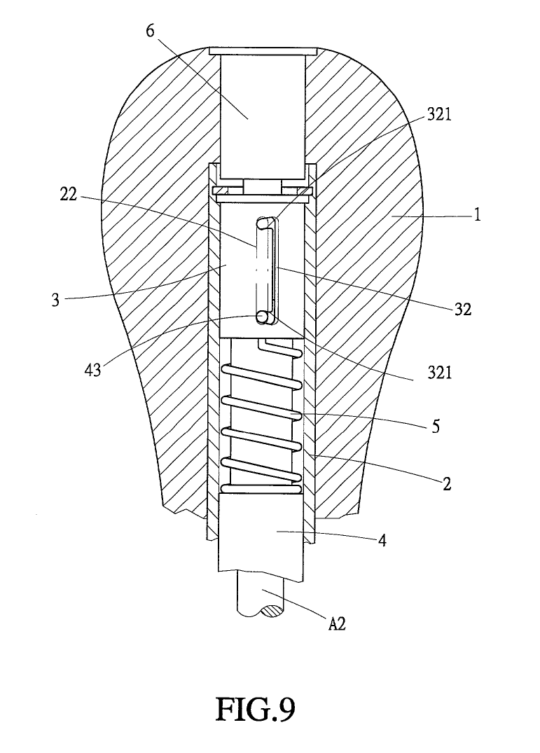

And as shown in FIG. 9, in the lock structure of the present invention, rotational sliding between the fixed sleeve 4 and the movable sleeve 2 is prevented by providing the stop notches 321 at the terminal ends of the second slot 32, thereby, the lateral edge of each of the stop notches 321 is formed to have a beveled recess to stop the positioning pin 43. This gives an increased stopping effect for the positioning pin 43 to avoid sliding due to inadvertent rotating of the shift lever head 1 to thereby release engagement between the fixed sleeve 4 and the movable sleeve 2.

In the engaging-by-gear-positions type shift lever lock of the present invention, rotational sliding action between the fixed sleeve and the movable sleeve is prevented by the rotatable block, and vertical sliding action between the shift lever head and the shank of the shift lever is prevented, and engagement at the transition position between an insertion portion and the channel for the gear positions is fixedly locked, an effect of locking the shift lever can thereby be achieved. Thereby, a preferred structure of shift lever is provided.

Having thus described my invention which is novel in structure and improved, what I claim as new and desire to be secured by Letters Patent of the United States are:

1. An engaging-by-gear-positions type shift lever lock, wherein, the shank of a shift lever is extended into a channel having a plurality of gear positions in a shift lever seat, transition of said gear positions on said channel makes gear shifting of said shank of said shift lever, said lock is characterized by:
said shank of said shift lever is provided on the top thereof with a shift lever head attached with an insertion portion, said shift lever head is adapted to displacing to allow said insertion portion to insert in said channel having said gear positions, a cylinder is provided for firmly locking said shift lever head on said shank of said shift lever, when said shift lever is moved to a transition position of said channel having said gear positions, said shift lever head is pulled down to render said insertion portion on the lower end thereof to insert in said shank of said shift lever and in a space at said transition position, said cylinder locks said insertion portion in its present position, thereby, said shank of said shift lever is engaged with said channel having said gear positions, and an effect of locking said shank of said shift lever is achieved.

2. An engaging-by-gear-positions type shift lever lock as claimed in claim 1, wherein,
a movable sleeve is provided in said shift lever head, said insertion portion is provided on the bottom of said shift lever head for insertion of said shank of said shift lever, and a fixed sleeve is fixedly provided on said shank of said shift lever, said movable sleeve is provided on the main body thereof with a receiving bore to allow inserting of said fixed sleeve therein; partial section of said fixed sleeve is a first slipping over portion being adapted to inserting into said receiving bore of said movable sleeve, the other section of said fixed sleeve is a second slipping over portion being adapted to inserting into a rotatable block, said fixed sleeve and said movable sleeve are respectively provided with a positioning pin and a first slot mutually cooperative, said rotatable block receives said positioning pin and is mounted between said fixed sleeve and said movable sleeve, and said cylinder is provided on said shift lever head and above said rotatable block to control rotation of said rotatable block; said rotatable block is provided thereon with a second slot being adapted to aligning with said first slot, and the upper and the lower terminal ends of said second slot forming the terminals of a moving stroke of said positioning pin are provided each with a stop notch, said lock as a whole is adapted to rotating by rotating said cylinder, said rotatable block allows said positioning pin to get into one of said stop notches and to be prevented from vertical sliding in said first slot by said stop notch, thereby, vertical sliding action between said shift lever head and said shank of the shift lever is prevented.

3. An engaging-by-gear-positions type shift lever lock as claimed in claim 2, wherein,
the top of said movable sleeve is directly slipped in a receiving hole from the bottom of said shift lever head, and is fixed by inserting therein a plurality of fixing pins.

4. An engaging-by-gear-positions type shift lever lock as claimed in claim 2, wherein,
said rotatable block is provided thereon with a flange which is adapted to receiving in a positioning annular groove in said receiving bore of said movable sleeve and is positioned here by a locking ring.

5. An engaging-by-gear-positions type shift lever lock as claimed in claim 2, wherein,
said shift lever head has a cylinder receiving hole located above said rotatable block to receive said cylinder.

6. An engaging-by-gear-positions type shift lever lock as claimed in claim 2, wherein,
the lateral edge of each of said stop notches is formed to have a beveled recess to stop said positioning pin.

7. An engaging-by-gear-positions type shift lever lock as claimed in claim 2, wherein,
a screw hole threaded connecting with a thread section on said shank of said shift lever is provided on the inner circle of said fixed sleeve.

8. An engaging-by-gear-positions type shift lever lock as claimed in claim 7, wherein,
a fixing screw is transversely screwed in said fixed sleeve and said shank of said shift lever to connect them in a locking state.

9. An engaging-by-gear-positions type shift lever lock as claimed in claim 8, wherein,
a fish-eye hole is provided on said fixed sleeve, a screw hole is provided on said movable sleeve at a location in corresponding to said fish-eye hole; thereby, when said movable sleeve is pulled down and is locked by said cylinder at the lower position thereof, said screw hole and said fish-eye hole do not align or communicate with each other by down moving of said movable sleeve, and said fixing screw does not expose to thereby prevent said fixed sleeve from detachment, said lock can thus avoid being destroyed at will.

10. An engaging-by-gear-positions type shift lever lock as claimed in claim 2, wherein,
a spring is provided at the end of said rotatable block to form an elastic restoring force and a reverse rotating force for said rotatable block.
